(19) United States
(12) Patent Application Publication
(10) Pub. No.: US 2024/0268243 A1
(43) Pub. Date: Aug. 15, 2024

(54) SHOVEL

(71) Applicant: Man Shovel, Ltd., Evergreen, CO (US)

(72) Inventors: Joel Hart, Evergreen, CO (US); Ryan Trevor Bramwell, Steamboat Springs, CO (US); Patrick Schloth, Louisville, CO (US)

(21) Appl. No.: 18/438,119

(22) Filed: Feb. 9, 2024

Related U.S. Application Data
(60) Provisional application No. 63/484,127, filed on Feb. 9, 2023.

(51) Int. Cl. A01B 1/02; B25G 1/10

(52) U.S. Cl. CPC A01B 1/02; B25G 1/10

(57) ABSTRACT

A shovel including a handle and a head. The handle includes a first grip portion and a second grip portion spaced from the first grip portion and located adjacent the second end. The head includes a tip and a collar disposed opposite the tip and coupling the handle and the head together. The head extends along an axis passing through the tip and a rearward portion of the head adjacent the collar. A center of gravity of the shovel is coincident with the handle.

### CROSS-REFERENCE TO RELATED APPLICATIONS

This application claims priority to U.S. Provisional Patent Application No. 63/484,127, filed on Feb. 9, 2023, and entitled “Shovel”, the contents of which are hereby incorporated by reference in its entirety.

### BACKGROUND

The present invention relates to a shovel, and more particularly to a shovel with a handle and a blade or head.

Conventional shovels come in different shapes depending on the type of use. Some existing shovels may include a step to assist with using the shovel (e.g., to dig a hole). Typically, the step on existing shovels has a length of approximately 1.5 inches or smaller and a width of approximately 0.5 inches or smaller, which results in a surface area of approximately 0.75 square inches.

### SUMMARY

In one embodiment, the disclosure provides a shovel including a handle and a head. The handle includes a first grip portion and a second grip portion spaced from the first grip portion and located adjacent the second end. The head includes a tip and a collar disposed opposite the tip and coupling the handle and the head together. The head extends along an axis passing through the tip and a rearward portion of the head adjacent the collar. A center of gravity of the shovel is coincident with the handle.

In another independent embodiment, the disclosure provides a shovel including a handle with a grip portion, and a head oriented along an axis. The head includes a collar configured to secure the head and the handle together and a tip. The tip is opposite the collar along the axis. The tip has an edge with a first side portion and a second side portion. The first side portion is oriented at a first angle relative to the axis, and the second side portion is orientated at second angle relative to the axis, the second angle different form the first angle.

In another independent embodiment, the disclosure provides a shovel including a handle including a grip portion, and a head. The head includes a tip, a collar disposed opposite the tip and coupling the handle and the head together. The head extends along an axis passing through the tip and a rearward portion of the head adjacent the collar. The head further includes a central spoon portion, an intermediate planar portion separated from the central spoon portion by an edge, and an outer planar portion separated from the intermediate planar portion by a spline. The spline is substantially triangular in cross-sectional shape perpendicular to the axis.

Other aspects of the disclosure will become apparent by consideration of the detailed description and accompanying drawings.

### BRIEF DESCRIPTION OF THE DRAWINGS

FIG. 1 is a front view of a trench shovel.

FIG. 2 is a front view of a round point shovel.

FIG. 3 is a front view of a square point shovel.

FIG. 4A is a side view of the trench shovel of FIG. 1.

FIG. 4B is a side view of another trench shovel.

FIG. 5 is a side view of the round point shovel of FIG. 2.

FIG. 6 is a side view of the square point shovel of FIG. 3.

FIG. 7 is a perspective view of a handle of the trench shovel of FIG. 1.

FIG. 8 is a front view of a trench shovel head of the trench shovel of FIG. 1.

FIG. 9 is a perspective view of the trench shovel head of FIG. 8.

FIG. 10 is another perspective view of the trench shovel head of FIG. 8.

FIG. 11 is a front view of a round point shovel head of the round point shovel of FIG. 2.

FIG. 12 is a perspective view of the round point shovel head of FIG. 11.

FIG. 13 is another perspective view of the round point shovel head of FIG. 11.

FIG. 14 is a front view of a square point shovel head of the square point shovel of FIG. 3.

FIG. 15 is a perspective view of the square point shovel head of FIG. 14.

FIG. 16 is another perspective view of the square point shovel head of FIG. 14.

FIG. 17 is a front view of an alternate trench shovel.

FIG. 18 is a front view of another alternate trench shovel.

FIG. 19 is a front view of another round point shovel.

Before any aspects are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

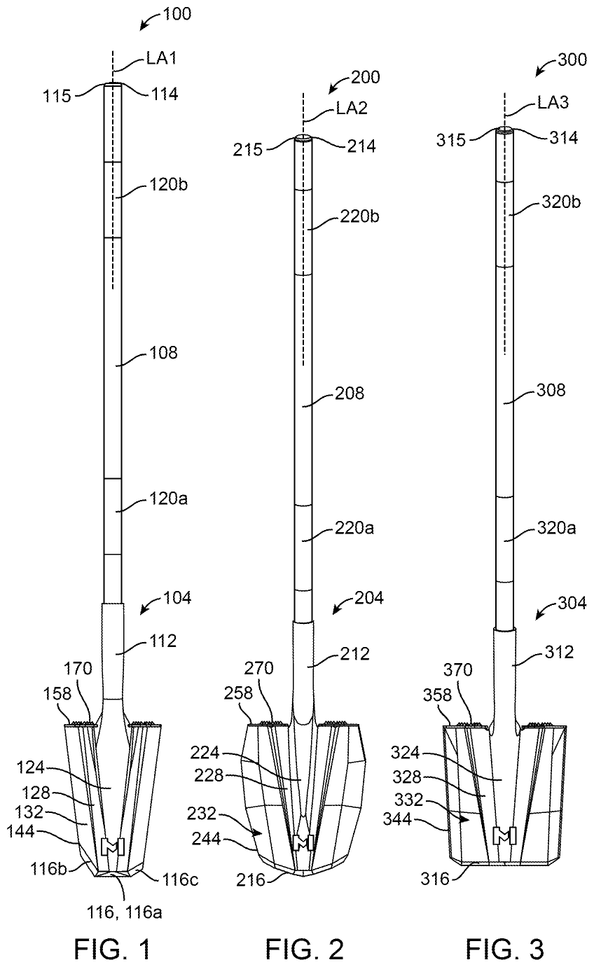

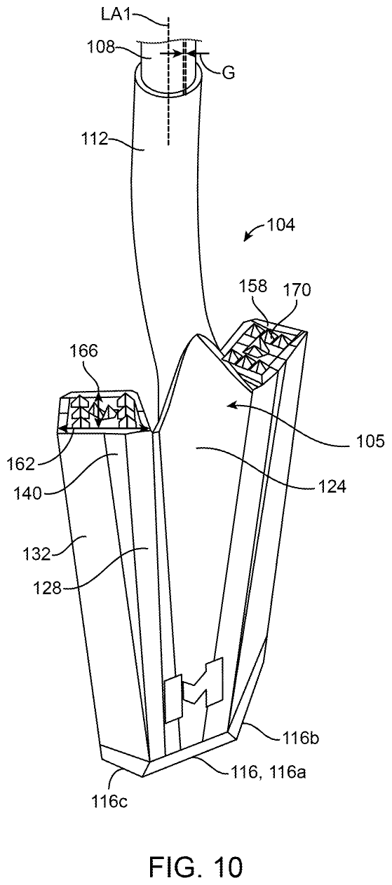

FIGS. 1-3 illustrate a trench shovel 100, a round point shovel 200, and a square point shovel 300, respectively. The trench shovel 100 is illustrated in FIGS. 1, 4, and 7-10. The trench shovel 100 includes a head or blade 104 and a handle 108. The head 104 includes a collar 112 that is located on one end of the head 104 and that secures the head 104 to the handle 108 (and vice versa). The handle 108 and the collar 112 may be secured to each other by a mechanical fastener, welding, or a combination thereof, or by other mechanisms (e.g., press-fit). The head 104 also includes a tip 116 on an end that is opposite the collar 112 to facilitate penetration of an object or surface (e.g., ground, a pile of material or debris, etc.). With reference to FIG. 10, the collar 112 surrounds the handle 108, although the collar 112 may not fully circumscribe the handle 108. The collar 112 has opposite lateral sides that are spaced from one another by a gap G. The gap G in the illustrated embodiment is approximately 0.06 inches, although other sizes of the gap G are possible and considered herein.

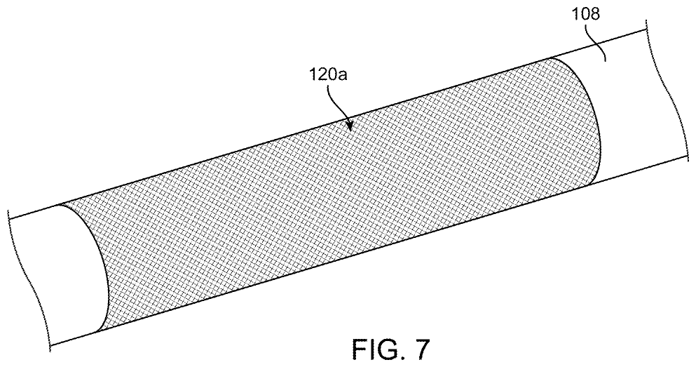

The handle 108 extends along a longitudinal axis LA1 and includes grip portions 120a, 120b. The grip portion 120a defines a lower grip portion of the trench shovel 100 that corresponds with a user's lower hand in use and that is positioned closer to the head 104 than the grip portion 120b. The grip portion 120b defines an upper grip portion of the trench shovel 100 that corresponds with a user's upper hand in use and that is spaced from the head 104 and the lower grip portion 120a and adjacent a distal end of the handle 108. As shown in FIG. 7, the grip portions 120a, 120b may include knurls (e.g., a fine volcano pattern), although the grip portions 120a, 120b may be made or defined in any other manner (e.g., color, material, etc.) different from the remainder of the handle 108. The grip portions 120a, 120b provide a visual and tactile indication to a user that the user is grasping the handle 108 at designated positions along the handle 108 corresponding with a center of gravity CG1 of the trench shovel 100. The illustrated trench shovel 100 weighs approximately 5.9 pounds. In some embodiments, the trench shovel 100 may weigh between 2 pounds and 10 pounds. In the illustrated embodiment, the handle 108 includes two grip portions 120a, 120b each providing a suggested location for one of the user's hands.

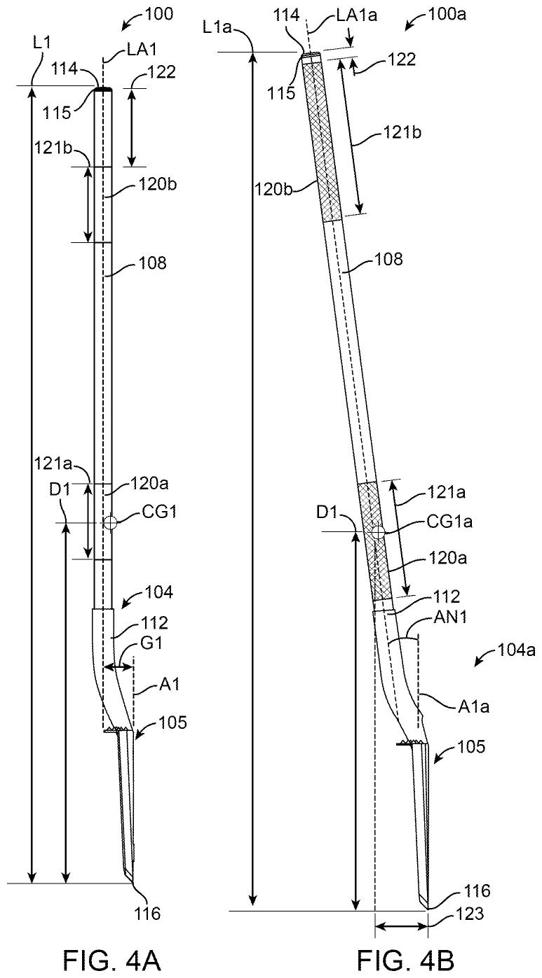

The center of gravity CG1 of the trench shovel 100 is positioned adjacent to, on, or within the area defining the lower grip portion 120a. As illustrated, the center of gravity CG1 is at the same height as the grip portion 120 (illustrated by distance D1 measured from the tip 116 in a direction along the longitudinal axis LA1). As shown in FIG. 4A, the trench shovel 100 extends a length L1 measured parallel to the longitudinal axis LA1 between an end 114 of the handle 108 (e.g., including an end cap 115) and the tip 116. The length L1 may be approximately 60 inches. The distance D1 from the tip 116 to the center of gravity CG1 of the trench shovel 100 may be between approximately 20 inches and 40 inches (e.g., between approximately 25 inches and 35 inches; between approximately 28.5 inches and 34.5 inches).

In the illustrated embodiment, the center of gravity CG1 is located at or adjacent a center of the lower grip portion 120a along the axis LA1. That is, the center of gravity CG1 is coincident with the handle 108 and with the lower grip portion 120a, and the center of gravity CG1 is located between a lower end and an upper end of the lower grip portion 120a. The center of gravity CG1 for the illustrated shovel 100 is a distance D1 from an end of the tip 116. In some embodiments, the center of gravity CG1 may be closer to, adjacent, or at the upper or lower boundaries (e.g., edges) of the lower grip portion 120a. For example, the center of gravity CG1 may adjacent or at the upper edge. In some embodiments, the center of gravity CG1 of the trench shovel 100 may be located just outside the grip portion 120a (e.g., positioned within three inches of the lower grip portion 120a) and coincident with the handle 108).

The position of the lower grip portion 120a is located on the handle 108 at a location that corresponds to the center of gravity CG1 of the trench shovel 100. This location of the lower grip portion 120a promotes user operation of the trench shovel 100 with the user's lower hand located at the center of gravity CG1 so that the user's hand acts as a fulcrum. Because the upper grip portion 120b is spaced from the lower grip portion 120a, the user's upper hand may operate (e.g., rotate) the head 104 about the user's lower hand (positioned at the lower grip portion 120a) with mechanical advantage. Any force applied to the handle 108 at the upper grip portion 120b is magnified at the head 104 due to torque balance about the fulcrum (e.g., at the lower grip portion 120a). The position of the center of gravity CG1 at the same height as the lower grip portion 120a provides a balanced feel to the user and promotes efficient use of the trench shovel 100.

The respective positions of the grip portions 120a, 120b on the shovel 100 may differ in some embodiments depending on the overall length L1 of the shovel 100 and/or the length of the head 104 and the handle 108. For example, the length L1 of the illustrated trench shovel 100 may be between 50 inches and 80 inches (e.g., between approximately 60 inches and 70 inches). In the embodiment illustrated in FIG. 4A, each the grip portion 120a, 120b extends a corresponding length 121a, 121b (measured parallel to or along the longitudinal axis LA1) of between approximately 4 inches and 12 inches along the handle 108. For example, the lower and upper grip portions 120a, 120b may be the same length (e.g., 6 inches, 8.5 inches, etc.), or the upper grip portion 120b may be longer (e.g., 11.5 inches) than the lower grip portion 120a (e.g., 8.5 inches), or vice versa. In the illustrated embodiment, the upper grip portion 120b is spaced from the end 114 a length 122 (measured parallel to or along the longitudinal axis LA1) between approximately 4 inches and 8 inches along the handle 108. In some embodiments, the length 122 may be less than 4 inches. In some embodiments, the length 122 from the end 114 to the upper grip portion 120b may be less than 2 inches. As shown in FIG. 4A, the upper grip portion 120b is approximately 6 inches from the end 114. Other dimensions relating to the grip portions 120a, 120b are possible and considered herein.

As illustrated in FIG. 4A, the head 104 extends along an axis A1 that is parallel to the longitudinal axis LA1 of the handle 108. The axis A1 is separated from the longitudinal axis LA1 by a gap G1. The axis A1 passes through the tip 116 and a rearward portion 105 of the head 104 adjacent the collar 112. In the illustrated embodiment, the gap G1 is between approximately 1 inch and 4 inches. The shape of the head 104 and the orientation of longitudinal axis LA1 of the handle 108 in parallel with the axis A1 promotes insertion of the head 104 downward in a direction parallel to the longitudinal axis LA1 and the axis A1 into a surface (e.g., ground, a pile of material or debris, etc.).

FIG. 4B illustrates another exemplary trench shovel 100a including components similar to the trench shovel 100, with like components labeled with the same reference numerals. With regard to the trench shovel 100a, the collar 112 is coupled to the handle 108 (e.g., by a mechanical fastener, by welding, etc.), and the handle 108 extends along a longitudinal axis LA1a. The head 104a extends along axis A1a (shown vertically in FIG. 4B, and the longitudinal axis LA1a is oriented at a non-zero angle AN1 relative to the axis A1a. The angle AN1 in the illustrated embodiment is approximately 8 degrees, although other angles are possible and considered herein. For example, the angle AN1 may be between 0 degrees and 45 degrees. The angle AN1 may be between 2.5 and 30 degrees. The angle AN1 may be between 5 degrees and 15 degrees. As to be expected, manufacturing tolerances may influence the angle AN1. For example, the angle AN1 may actually be greater than or less than one degree from a desired angle AN1 (e.g., 7.8 degrees). The length L1a of the trench shovel 100a is approximately 63 inches, although other lengths are possible and considered herein.

The trench shovel 100a includes grip portions 120a, 120b with respective lengths 121a, 121b (e.g., approximately 6 inches long or longer). As illustrated in FIG. 4B, the length 121a is approximately 8.5 inches, and the length 121b is approximately 11.5 inches. The illustrated upper grip portion 120b is spaced from the end 114 by a length 122 of less than 4 inches (measured parallel to the longitudinal axis LA1a).

The center of gravity CG1a of the trench shovel 100a is substantially aligned with a center of the lower grip portion 120a. The center of gravity CG1a of the trench shovel 100a is located at a distance D1 that is measured along the axis A1a from the tip 116. More specifically, the center of gravity CG1 of the trench shovel 100a is within the bounds of the lower grip portion 120a. In the illustrated embodiment, the distance D1 is approximately 28 inches. In some constructions, the distance D1 may be longer or shorter than 28 inches. As shown, the center of gravity CG1a is offset from the tip 116 by a lateral distance 123 (horizontal as shown in FIG. 4B) that is measured from the axis A1a extending along the head 104a. In the illustrated embodiment, the lateral distance 123 is approximately 3.75 inches, although the lateral distance may have other values (e.g., due in part to the angle of the handle 108 or other factors).

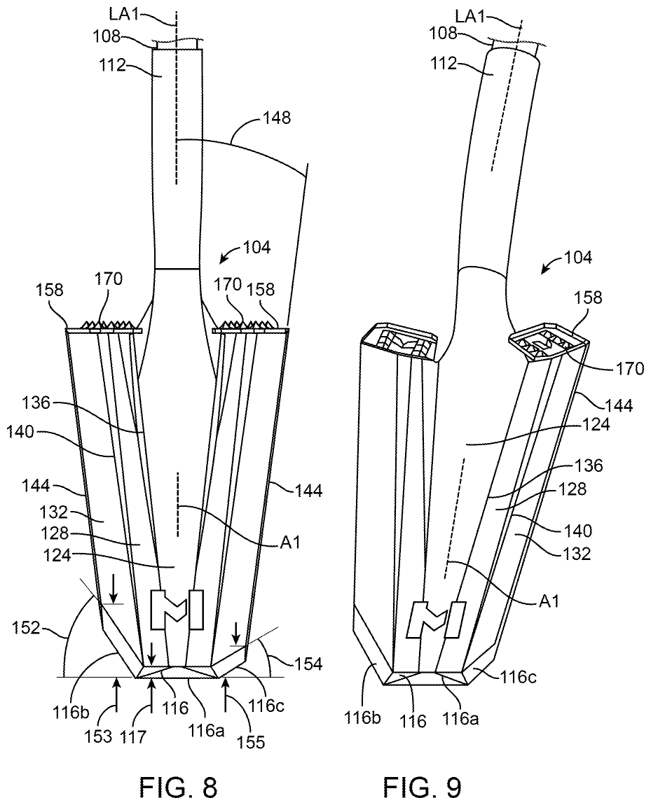

FIGS. 8 and 9 illustrate the head 104 of the trench shovel 100. The head 104 includes a central spoon portion 124, a pair of opposite intermediate planar portions 128, and a pair of opposite outer planar portions 132. The central spoon portion 124 and the intermediate planar portions 128 define a central portion of the head 104. As illustrated, the central spoon portion 124 is separated from the intermediate planar portions 128 by edges 136 (e.g., formed by bends), and the intermediate planar portions 128 are separated from the outer planar portions 132 by a spline 140 (e.g., formed by one or more bends). The spline 140 is disposed along a boundary of the central portion.

In the illustrated embodiment, the central spoon portion 124 transitions the intermediate planar portions 128 into the collar 112 for connection of the head 104 to the handle 108. As shown, the central spoon portion 124 is in the shape of a tapered cone with a smaller cone diameter disposed adjacent the tip 116 and a larger cone diameter disposed adjacent the collar 112 to accommodate the handle 108. In the illustrated embodiment, the pair of opposite intermediate planar portions 128 and the pair of opposite outer planar portions 132 are each substantially planar. It will be appreciated that the planar portions 128, 132 may include other features and/or depressions. In the illustrated embodiment, the spline 140 is substantially triangular in cross-sectional shape (in a plane perpendicular to the axis A1) and has a variable cross-sectional size along the axis A1. In the illustrated embodiment, the spline 140 has a first tip cross-sectional size at a location closer to the tip 116 that is smaller than a second cross-sectional size taken perpendicular to the axis A1 at a location closer to the collar 112. In the illustrated embodiment, the cross-sectional size of the spline 140 increases along the length of the axis A1 from the tip 116 to the collar 112. The outer planar potions 132 each terminate at outer lateral edges 144. The outer lateral edges 144 are angled relative to the longitudinal axis LA1 and thus the axis A1 at an angle 148. In the illustrated embodiment, the angle 148 is approximately 7 degrees. In other embodiments, the angle 148 may be between 1 degree and 45 degrees. With reference to FIGS. 8 and 9, the spline 140 is flared relative to the axis A1. In the illustrated embodiment, the spline 140 is flared an amount generally corresponding with the angle 148 such that the spline 140 is parallel or substantially parallel to the lateral edges 144. In other embodiments, the spline 140 may be flared amounts that differ from the angle 148. For example, the spline 140 may be flared more than 5 degrees or more than 20 degrees when compared to the angle 148.

As best illustrated in FIG. 8, the tip 116 of the trench shovel 100 has a central portion 116a that extends substantially perpendicular or perpendicular to the longitudinal axis LA1, and a pair of opposite side portions 116b, 116c. The side portion 116b and the side portion 116c are asymmetrical about the longitudinal axis LA1. More specifically, the side portion 116b extends linearly away from the central portion 116a and toward the outer lateral edge 144 at an angle 152 relative to a plane or axis extending on the central portion 116a. In the illustrated embodiment, the angle 152 is approximately 50 degrees, although the angle 152 may be between 1 degree and 89 degrees. The side potion 116b meets the outer lateral edge 144 at a point where the side portion 116b has a height 153 of approximately 2.3 inches. In some embodiments, the height 153 may be between approximately 0.1 inches and 12 inches.

The side portion 116c is oriented at an angle 154 from the central portion 116b that is different from the angle 152. In the illustrated embodiment, the angle 154 is approximately 30 degrees, although the angle 154 may be between 1 degree and 89 degrees (and still different from the angle 152). In other embodiments, the angle 154 may be the same as the angle 152. The side portion 116c meets the corresponding outer lateral edge 144 at a point where the side portion 116c has a height 155 of approximately 1 inch. In general, the height 155 is different from the height 153 (e.g., between approximately 0.1 inches and 12 inches), although the heights 153, 155 may be the same in some embodiments. In the illustrated embodiment, the heights 153, 155 differ and thus the side portions 116b, 116c meet the lateral edges 144 at different heights with respect to the central portion 116a of the tip 116 (i.e. at different axial positions along the axis A1). The asymmetric shape of the tip 116 permits a user to use either of the side portions 116b, 116c depending on the task at hand, including penetrating a surface or cutting through an object.

The tip 116 is beveled (e.g., a K bevel, etc.) to provide a sharpened blade (e.g., asymmetric) that promotes penetration of the head 104 into a material (e.g., to form a trench). The illustrated tip 116 defines a bevel depth 117 that transitions the thickness of the head 104 at the tip 116 to the remainder of the head 104. In the illustrated embodiment, the bevel depth 117 extends approximately 0.3 inches away from the tip 116. It will be appreciated that the bevel depth 117 may be shorter or longer, corresponding with a more or less severe bevel at the tip 116 (e.g., the bevel depth 117 may extend between 0.1 inches and 2 inches away from the tip 116).

The head 104 also includes one or more steps 158 (e.g., two steps 158 are shown). The illustrated steps 158 are rectangular or substantially rectangular in shape, and the steps are planar or substantially planar in a direction perpendicular to or across the axis A1. With reference to FIG. 10, an upper end of the splines 140 interfaces with the steps 158. As shown in FIGS. 8-10, the head 104 includes two steps 158 on opposite sides of the collar 112 (i.e. on opposite sides of the longitudinal axis LA1 and opposite sides of the handle 108). The steps 158 are located at similar or the same axial positions along the longitudinal axis LA1. The steps 158 are oversized relative to existing shovels with steps for ease of use of the trench shovel 100. As shown in FIG. 10, each step 158 includes a length 162 and a width 166. As shown, each step 158 is connected to at least a portion of the top edge of the outer planar portion 132 and the intermediate planar portion 128, and the step 158 extends outward from adjacent the collar 112 in a manner that is angled acutely relative to the longitudinal axis LA1 (the length 162 extends along the top of the corresponding outer planar portion 132 and the intermediate planar portion 128). The width 166 extends perpendicular to the length 162. As shown, the steps 158 have the same lengths 162 and widths 166, although one step 158 may have a different length and/or width relative to the other step 158. The steps 158 are oversized relative to conventional steps (e.g., the length 162 of the illustrated steps 158 may be approximately 2.5 inches, and the width 166 may be approximately 1.5 inches). Stated another way, each step 158 defines an oversized surface that may have a surface area of approximately 3.75 square inches. In some embodiments, the length 162 and/or width 166 of the step 158 may differ to provide different-sized (e.g., oversized) surface areas for improved access and use of the step(s) 158. For example, each step 158 may have a surface area greater than approximately 2 square inches. In some embodiments, each step 158 may have surface area greater than approximately 4 square inches. In other embodiments, each step 158 may have surface area greater than approximately 6 square inches.

With reference to FIGS. 8 and 10, each step 158 includes a plurality of studs 170 that are disposed on a top surface of the steps 158 and that provide enhanced grip for a user to engage the steps 158. In the illustrated embodiment, each of the studs 170 is a substantially pyramid-shaped protrusion that extends in a direction away from the tip 116 and that faces the user during operation of the trench shovel 100. As shown, the studs 170 extend a height of approximately one-eighth of an inch (0.13 inches), although other heights are possible and considered herein. The studs 170 may be formed by a stamping process or another process to define an array of studs 170 (e.g., a rectangular array with the studs 170 arranged in rows or columns) for selective engagement by a user. The studs 170 may be spaced uniformly or non-uniformly (e.g., spacing may be greater along the length 162 than the width 166) on the step 158. In the illustrated embodiment, the studs 170 are spaced along the length 162 approximately 0.5 inches from each other, and the studs 170 are spaced along the width 166 approximately 0.3 inches from each other. In some embodiments, the arrangement of the studs 170 may have a specific shape (e.g., in the form of an ‘M’). Other arrangements (e.g., differing logos, geometric patterns, etc.) of studs 170 are possible and considered herein.

During operation of the trench shovel 100, a user may place their foot on one of the steps 158 to push and provide a force on the head 104 to, for example, dig or cut a trench. Force exerted on the steps 158 may be transmitted at least partially by the splines 140 to the tip 116. In some embodiments, different types of structural reinforcement members (e.g., gussets, columns, ribs, supports, etc.) may be positioned between the steps 158 and one or more of the intermediate planar portions 128, the outer planar portions 132, the splines 140, and the central spoon portion 124 to provide rigidity to the head 104. These structural reinforcement members may be strategically placed and dimensioned, and may be made of structurally rigid material based on material and strength analysis of the steps 158 and the trench shovel 100 to improve the rigidity of the steps 158.

The illustrated head 104 and handle 108 may be made from high quality steel such as 4140 (e.g., molybdenum) or 5160 (e.g., high carbon and chromium) steel. In some embodiments, the head 104 and/or the handle 108 may be quenched and tempered. These material and manufacturing choices for the head 104 allow the head 104 to have high strength and toughness as well as exhibit high ductility, fatigue, and corrosion resistance. While steel such as 4140 and 5160 steel provide exemplary choices for the head 104, other materials may be selected. Similarly, these materials may provide adequate chemistries for welds to secure the head 104 to the handle 108 in some embodiments. In the illustrated embodiment, the head 104 and the handle 108 may be formed separately from each other and thereafter assembled and attached. After separate manufacturing, the gap G permits the handle 108 to be inserted into the collar 112 of the head 104. A high-strength weld (e.g., a fillet weld, a seam weld, etc.) is applied to the interface between head 104 and the handle 108 at the collar 112 to secure the head 104 and handle 108 to one another. In the illustrated embodiment, a seam weld is applied along the gap G, and a fillet weld is applied at an axial end of the collar 112 closest to the end 114.

In some embodiments, the end 114 of the handle 108 may include an end cap 115. Such an end cap 115 may be press-fit into the handle 108 concurrent with press-fit insertion of the handle 108 into the collar 112, or the end cap 115 may be otherwise coupled to the end 114 of the handle 108 (e.g., the end cap 115 may be press-fit onto the handle 108 before or after the handle 108 and the collar 112 are connected, or the end cap 115 may be secured to the handle 108 by adhesive or other mechanical attachment mechanisms). Stated another way, the end cap 115 may be coupled to the handle 108 concurrent or consecutive with attachment of the handle 108 to the head 104, and the end cap 115 may be attached to the first end 114 in any suitable manner.

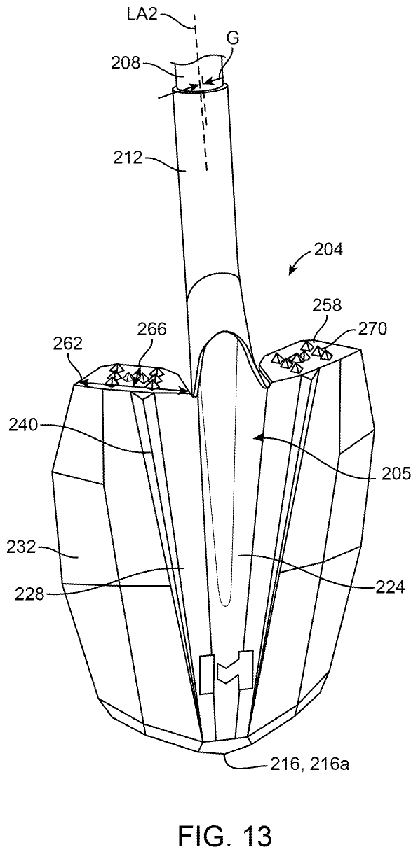

FIGS. 2, 5, and 11-13 illustrate the exemplary round point shovel 200. The shovel 200 includes some features that are the same or similar to features of the shovel 100, and these features are identified in FIGS. 2, 5, and 11-13 are labeled with the same reference numerals plus 100 (i.e. in the ‘200’ series of reference numerals).

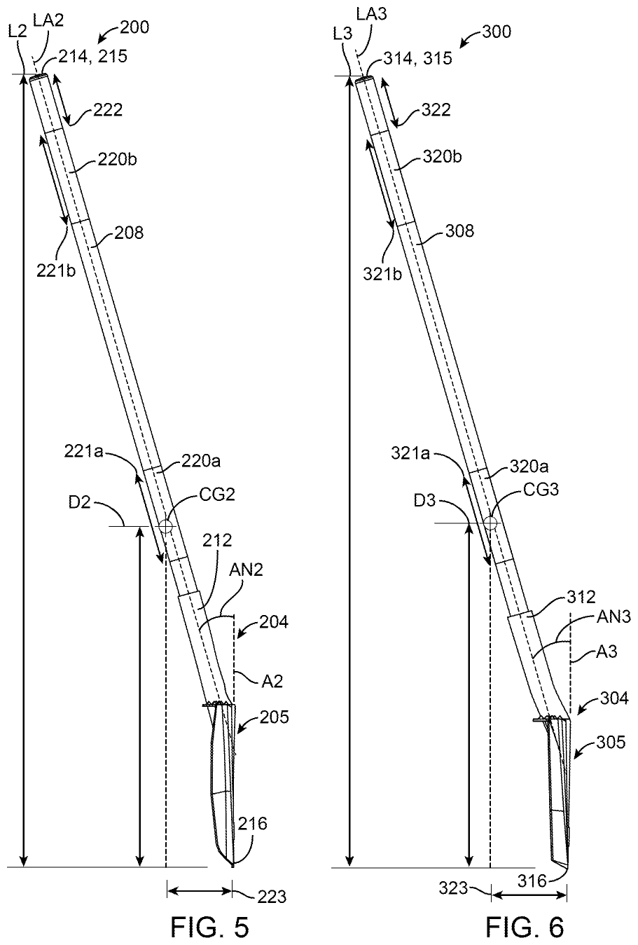

With reference to FIG. 5, the head 204 of the round point shovel 200 extends along an axis A2 that is arranged at an angle AN2 relative to a longitudinal axis LA2 defined by the handle 208. The illustrated angle AN2 is approximately 16 degrees (e.g., 15-17 degrees). Other angles are possible and considered herein. For example, the angle AN2 may be between 0 degrees (the axes LA2 and A2 would be parallel) and 45 degrees. As shown in FIG. 5, a length L2 of the round point shovel 200 is approximately 60 inches.

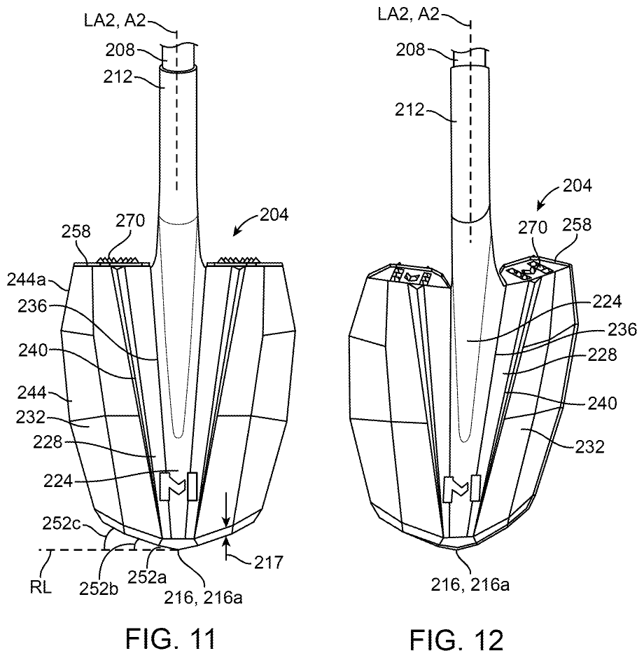

With reference to FIGS. 2 and 11-12, the tip 216 has a plurality of line segments. The tip 216 includes a point 216a that is centrally positioned in alignment with the longitudinal axis LA2 and the axis A2. The line segments of the tip 216 are increasingly (e.g., progressively) angled away from a reference line RL perpendicular to the axis A2 as illustrated by angles 252a-252c. The line segments of the tip 216 adjacent the central spoon portion 224 (e.g., adjacent the point 216a) are only slightly angled away from the reference line RL (see angle 252a). The next line segment of the tip 216 is angled (see angle 252b) a greater amount than the line segment of the tip 216 adjacent the central spoon portion 224, and so on (angle 252c) to the lateral edge 244. The lateral edge 244 has increasingly angled or progressively angled line segments relative to the lower portions (as viewed in FIG. 11) up the head 204 toward the step 258 such that each progressive segment is more steeply angled relative to horizontal (i.e. closer to parallel with the axis A2 than the lower segment, or having a smaller angle relative to the axis A2 compared to the lower segment), and the lateral edge 244 has a top portion 244a that is parallel with or angled toward the axis A2. The tip 216 is shaped to penetrate a surface, and the central spoon portion 224, the intermediate planar portions 228, and the outer planar portions 232 cooperatively define a large volume for the shovel 200 to capture, move, and/or remove debris.

The description above regarding to the center of gravity CG1 of the trench shovel 100 and the trench shovel 100a applies equally to the center of gravity CG2 of the round point shovel 200. The center of gravity CG2 of the round point shovel 200 is positioned adjacent to, on, or within the area defining the lower grip portion 220a. As illustrated, the center of gravity CG2 is at the same height as the grip portion 220a (illustrated by distance D2 measured perpendicularly from the tip 216). As shown in FIG. 5, the center of gravity CG2 of the round point shovel 200 is a distance D2 from an end of the tip 216. The distance D2 from the tip 216 to the center of gravity CG2 of the round point shovel 200 may be between approximately 20 inches and 40 inches (e.g., between approximately 22 inches and 30 inches, between approximately 23 inches and 25 inches). In some constructions, the distance D2 may be larger than 40 inches or smaller than 20 inches. The distance D2 of the illustrated round point shovel 200 is approximately 24 inches (e.g., 23.8 inches). The center of gravity CG2 is coincident with the handle 208 and with the lower grip portion 220a, and the center of gravity CG2 is located between a lower end and an upper end of the lower grip portion 220a. The center of gravity CG2 and the axis A2 (along which the head 204 extends) are separated a lateral distance 223 of approximately 5 inches (e.g., 4.9 inches), although the lateral distance 223 may be larger or smaller than 5 inches.

Similarly, the handle 208 of the round point shovel 200 may include grip portions 220a, 220b with lengths 221a, 221b (measured parallel or along the longitudinal axis LA2) of between 4 inches and 12 inches. The lower and upper grip portions 220a, 220b may be the same length (e.g., 6 inches, 8 inches, etc.), or the upper grip portion 220b may be longer (e.g., 11.5 inches) than the lower grip portion 220a (e.g., 8.5 inches), or vice versa.

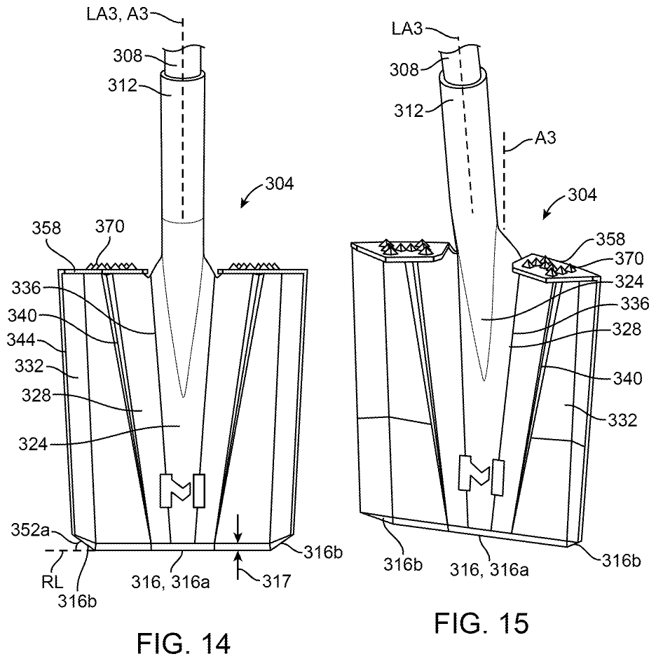

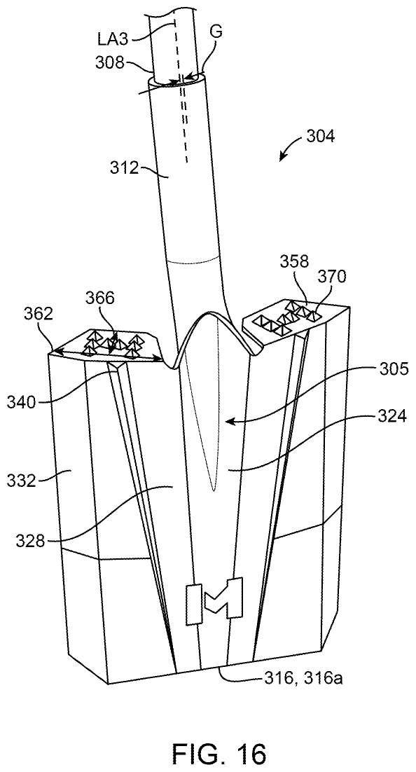

FIGS. 3, 6, and 14-16 illustrate the square point shovel 300. With reference to FIG. 6, the head 304 of the square shovel 300 extends along an axis A3 that is disposed at an angle AN3 relative to a longitudinal axis LA3 defined by the handle 308. The illustrated angle AN3 is approximately 16 degrees (e.g., 15-17 degrees), although the angle AN3 may be larger or smaller, and other angles are possible and considered herein. For example, the angle AN3 may be between 0 degrees (i.e. the axes LA3 and A3 would be parallel) and 45 degrees. In the illustrated embodiment, the round point shovel 200 has a length L3 (e.g., approximately 60 inches).

With reference to FIGS. 3 and 14-16, the tip 316 of the square shovel 300 is provided in a plurality of line segments. The segments of the tip 316 adjacent the central spoon portion 324 are perpendicular or substantially perpendicular to the axis A3. Segments of the tip 316 adjacent the lateral edges 344 of the square shovel 300 are angled away from the axis A3. As shown, the lateral edges 344 are only slightly angled relative to the axis A3 such that the head 304 of the square shovel 300 is substantially square shaped. The shape of the head 304 defines a relatively flat or completely flat surface for the head 304 to slide along a flat surface to gather debris. The central spoon portion 324, the intermediate planar portions 328, and the outer planar portions 332, define a large volume to capture, move, and/or remove material.

The description above regarding to the center of gravity CG1 of the trench shovel 100 and the trench shovel 100a applies equally to the center of gravity CG3 of the square point shovel 300. The center of gravity CG3 of the square point shovel 300 is positioned adjacent to, on, or within the area defining the lower grip portion 320a. As illustrated, the center of gravity CG3 is at the same height as the grip portion 320a (illustrated by distance D3 measured perpendicularly from the tip 316). As shown in FIG. 6, the center of gravity CG3 of the square point shovel 300 is a distance D3 from and end of the tip 316. The distance D3 from the tip 316 to the center of gravity CG3 of the square point shovel 300 may be between approximately 20 inches and 40 inches (e.g., between approximately 21 inches and 30 inches, between approximately 22 inches and 4 inches). The distance D3 of the illustrated square point shovel 300 is approximately 23 inches (e.g., 22.7 inches). In the illustrated embodiment, the center of gravity CG3 is a distance D3 from the tip 316 (measured parallel to the axis A3). In the illustrated embodiment, the distance D3 is approximately 23 inches (e.g., 22.7 inches), although the distance D3 may be different based on factors such as handle length, head length, and materials used. The center of gravity CG3 is coincident with the handle 308 and with the lower grip portion 320a, and the center of gravity CG3 is located between a lower end and an upper end of the lower grip portion 320a. The center of gravity CG3 and the axis A3 (along which the head 304 extends) are separated by a lateral distance 323 that is approximately 5 inches (e.g., 4.8) inches, although the lateral distance 323 may be shorter or longer based on several factors (materials/weight of the head 304 and the handle 308, respective lengths of the head 304 and the handle 308, etc.).

Similarly, the handle 308 of the square point shovel 300 may include grip portions 320a, 320b with lengths 321a, 321b (measured parallel or along the longitudinal axis LA3) of between 4 inches and 12 inches. The lower and upper grip portions 320a, 320b may be the same length (e.g., 6 inches, 8 inches, etc.), or the upper grip portion 320b ay be longer (e.g., 11.5 inches) than the lower grip portion 320a (e.g., 8.5 inches), or vice versa.

FIG. 17 illustrates a trench shovel head 404 including a collar 412, a tip 416, and a lateral edge 444. The tip 416 has a central portion that is angled relative to a reference line RL that is perpendicular to an axis A4 of the collar 412. Stated another way, the central portion of the tip 416 defines a concave space relative to the reference line RL. The tip 416 includes a central tip point 416a that is aligned or substantially aligned with the axis A4, and two side tip points 416a that are on opposite sides of the central tip point 416a and that are laterally spaced from the axis A4. The side tip points 416a are positioned axially further along the axis A4 when compared to the central tip point 416a. In the illustrated embodiment, the side tip points 416a are laterally spaced the same amount from the axis A4 such that the trench shovel head 404 is symmetrical about the axis A4. Laterally beyond the tip points 416a, the tip 416 includes a plurality of line segments which are increasingly (e.g., progressively) angled away from the reference line RL. The lateral edges 444 are substantially parallel to the axis A4, and the lateral edges 444 are substantially perpendicular to the reference line RL. Adjacent to the steps 458, the lateral edges 444 include flared portions 444a which flare laterally outwardly in a direction away from the axis A4.

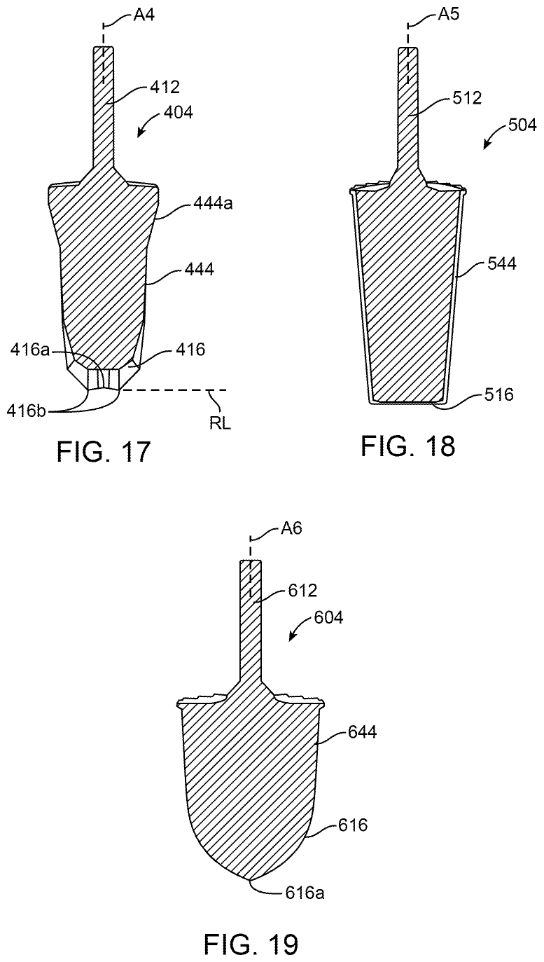

FIG. 18 illustrates another exemplary trench shovel head 504 having a tip 516 which is substantially planar and does not include angled and/or asymmetric side portions (similar to or the same as the above-described side portions 116b, 116c).

FIG. 19 illustrates another exemplary round point shovel head 604 having a tip 616 which is rounded to a point 616a. The point 616a is aligned with an axis A6 of a collar 612 of the spade shovel head 604. Other embodiments are envisioned.

Although aspects of the invention have been described in detail with reference to certain preferred embodiments, variations and modifications exist within the scope of one or more independent aspects as described.

Various features and advantages of the disclosure are set forth in the following claims.

1. A shovel comprising:
a handle including a first end, a second end opposite the first end, a first grip portion, and a second grip portion spaced from the first grip portion and located adjacent the second end; and
a head including a tip and a collar disposed opposite the tip and coupling the handle and the head together, the head extending along an axis passing through the tip and a rearward portion of the head adjacent the collar,
wherein a center of gravity of the shovel is coincident with the handle.

2. The shovel of claim 1, wherein the first grip portion and the second grip portion have the same length.

3. The shovel of claim 1, wherein the center of gravity of the shovel is offset from the axis by a lateral non-zero distance.

4. The shovel of claim 1, wherein the center of gravity is located within the bounds of the first grip portion.

5. The shovel of claim 1, wherein the second grip portion is longer than the first grip portion.

6. The shovel of claim 1, wherein each of the first grip portion and the second grip portion is defined in a manner different from the remainder of the handle.

7. The shovel of claim 6, wherein the first grip portion includes knurls configured to provide a visual indication and a tactile indication of a position along the handle corresponding with the center of gravity.

8. The shovel of claim 1, wherein the axis is a first axis and the handle is oriented along a second axis disposed at a non-zero angle relative to the first axis.

9. The shovel of claim 1, wherein the head further includes one or more splines extending between the tip and the collar along the axis, and wherein the one or more splines have a triangular shape in cross-section taken perpendicular to the axis.

10. The shovel of claim 1, wherein the first grip portion is colored differently from the remainder of the handle to provide a visual indication of a position along the handle corresponding with the center of gravity.

11. The shovel of claim 1, wherein the handle includes a first material and the first grip portion includes a second material that is different from the first material and configured to define one or both of a visual indication and a tactile indication of a position along the handle corresponding with the center of gravity.

12. The shovel of claim 1, wherein the head further includes a step having a surface area of greater than 3 square inches in a plane perpendicular to the axis, and wherein the step includes a plurality of studded protrusions extending along the axis and away from the tip.

13. A shovel comprising:
a handle including a grip portion;
a head oriented along an axis, the head including
a collar configured to secure the head and the handle together, and
a tip opposite the collar along the axis, the tip having an edge with a first side portion and a second side portion, the first side portion being oriented at a first angle relative to the axis, and the second side portion being oriented at a second angle relative to the axis, the second angle different from the first angle.

14. The shovel of claim 13, further comprising a central portion between the first side portion and the second side portion, wherein the head further includes one or more splines extending between the tip and the collar along the axis.

15. The shovel of claim 13, wherein the head includes lateral edges that are angled relative to the axis, and wherein the first side portion and the second side portion meet the lateral edges at different heights.

16. The shovel of claim 13, wherein the tip is beveled and defines a bevel depth extending away from the tip that transitions a thickness of the head from the tip to the remainder of the head, and wherein the bevel depth is larger than 0.2 inches.

17. A shovel comprising:
a handle including a grip portion, and
a head including:
a tip;
a collar disposed opposite the tip and coupling the handle and the head together, the head extending along an axis passing through the tip and a rearward portion of the head adjacent the collar;
a central portion; and
a spline disposed along a boundary of the central portion and having a triangular shape in cross-section taken perpendicular to the axis.

18. The shovel of claim 17, wherein the head further includes an outer portion separated from the central portion by the spline.

19. The shovel of claim 17, wherein the triangular shape of the spline varies in size along the axis between the tip and the collar.

20. The shovel of claim 17, wherein the spline is a first spline and the head includes a second spline symmetrically disposed relative to the first spline about the axis.
